(19) United States
(12) Patent Application Publication
(10) Pub. No.: US 2019/0002756 A1
(43) Pub. Date: Jan. 3, 2019

(54) SELF-SUSPENDING PROPPANTS MADE FROM POWDERED HYDROGEL-FORMING POLYMERS

(71) Applicant: Self-Suspending Proppant LLC, Chesterland, OH (US)

(72) Inventors: Kevin P. Kincaid, Salt Lake City, UT (US); Huaxiang Yang, Sugar Land, TX (US); Kanth Josyula, Sugar Land, TX (US); Vinay Mehta, Richmond, TX (US)

(21) Appl. No.: 15/952,459

(22) Filed: Apr. 13, 2018

Related U.S. Application Data
(60) Provisional application No. 62/526,614, filed on Jun. 29, 2017.

(51) Int. Cl. C09K 8/80; C09K 8/68; C09K 8/92

(52) U.S. Cl. CPC C09K 8/805; C09K 8/92; C09K 8/685

(57) ABSTRACT

The durability of a self-suspending proppant which is made by applying a layer of a hydrogel-forming polymer in powder form to a binder carried on the surfaces of a proppant particle substrate is improved by applying a crosslinking agent for polymer to these powder particles after they have been bound to the binder.

### CROSS-REFERENCE TO RELATED APPLICATION

This application claims priority to and all benefit of U.S. Provisional Patent Application Ser. No. 62/526,614, filed on Jun. 29, 2017, the entire disclosure of which is fully incorporated herein by reference.

### FIELD OF THE INVENTION

This application relates generally to fracturing technologies, particularly to proppants used in fracturing technologies and methods related thereto.

### BACKGROUND

U.S. Pat. No. 8,661,729 and related disclosures describe proppants useful for hydraulic fracturing which are made by coating a sand or ceramic proppant particle substrate with a binder followed by coating the binder with a dry powder of a hydrogel-forming polymer. When exposed to water, the hydrogel-forming polymer particles purportedly expand through absorption of water. The reported result is that the substrates travel more readily with the flow of fluid without settling out.

However, to be commercially viable, the proppant should do more than absorb fluid. Rather, it should also be durable in the sense of resisting degradation before it reaches its ultimate use location downhole. In addition, it should also be storage stable in the sense of resisting caking and/or agglomeration during storage and transport, especially when exposed to high humidity conditions in summertime.

### SUMMARY

In accordance with this invention, it has been found that both the durability as well as the storage satiability of proppants of the type mentioned above can be significantly improved by over-coating the proppant with a crosslinking agent capable of reacting with the hydrogel-forming polymer.

Thus, this invention provides a self-suspending proppant comprising a proppant particle substrate, a binder on the surface(s) of the proppant particle substrate, and a layer of a powder comprising a hydrogel-forming polymer bound to the surface(s) of the proppant particle substrate by the binder, wherein the self-suspending proppant further comprises a crosslinked shell formed by applying a crosslinking agent for the hydrogel-forming polymer to the layer of hydrogel-forming polymer powder.

In addition, this invention also provides a process for improving the durability of a self-suspending proppant comprising a proppant particle substrate, a binder on the surface(s) of the proppant particle substrate, and a layer of a hydrogel-forming polymer in form of powder particles bound to the surface(s) of the proppant particle substrate by the binder, the process comprising applying a crosslinking agent capable of crosslinking the hydrogel-forming polymer to these powder particles after they have been contacted with the binder.

In addition, this invention also provides a process for improving the durability of a self-suspending proppant comprising a proppant particle substrate, a binder on the surface(s) of the proppant particle substrate, and a layer of powdered hydrogel-forming polymer on the binder, wherein the powdered hydrogel-forming polymer is contacted with the binder by adding the powdered hydrogel-forming polymer to a mixture of the proppant particle substrate and the binder, the process comprising applying a crosslinking agent capable of crosslinking the hydrogel-forming polymer to the mixture of the proppant particle substrate and the binder after the powdered hydrogel-forming polymer is added to this mixture.

### DETAILED DESCRIPTION

### Proppant Particle Substrate

The inventive self-suspending proppants take the form of a proppant particle substrate carrying a coating of a hydrogel-forming polymer in powder form which is bound to the proppant particle substrate by an intermediate layer of an appropriate binder (adhesive).

For this purpose, any particulate solid which has previously been used or may be used in the future as a proppant in connection with the recovery of oil, natural gas and/or natural gas liquids from geological formations can be used as the proppant particle substrate of the inventive self-suspending proppants. These materials can have densities as low as ˜1.2 g/cc and as high as ˜5 g/cc and even higher, although the densities of the vast majority will range between ˜1.8 g/cc and ˜5 g/cc, such as for example ˜2.3 to ˜3.5 g/cc, ˜3.6 to ˜4.6 g/cc, and ˜4.7 g/cc and more.

Specific examples include graded sand, resin coated sand including sands coated with curable resins as well as sands coated with precured resins, bauxite, ceramic materials, glass materials, polymeric materials, resinous materials, rubber materials, nutshells that have been chipped, ground, pulverized or crushed to a suitable size (e.g., walnut, pecan, coconut, almond, ivory nut, brazil nut, and the like), seed shells or fruit pits that have been chipped, ground, pulverized or crushed to a suitable size (e.g., plum, olive, peach, cherry, apricot, etc.), chipped, ground, pulverized or crushed materials from other plants such as corn cobs, composites formed from a binder and a filler material such as solid glass, glass microspheres, fly ash, silica, alumina, fumed carbon, carbon black, graphite, mica, boron, zirconia, talc, kaolin, titanium dioxide, calcium silicate, and the like, as well as combinations of these different materials.

Especially interesting are normal frac sand and other light weight ceramics (densities ˜1.6-2.0 g/cc), intermediate density ceramics (density ˜2.0-3.4 g/cc), bauxite and high density ceramics (density ˜3.4-5 g/cc), just to name a few. Resin-coated versions of these proppants, and in particular resin-coated conventional frac sand, are also good examples.

Preferred proppant particle substrates are conventional “frac” sands, commonly sized as 20/40, 30/50, 40/70 or 100 mesh sands. Preferably, they are washed and dried, since unwashed sands can have debris that negatively impacts bonding integrity. Preferably, they are also well sorted with as narrow of a size distribution as possible, in accordance with conventional practice. Well sorted, narrowly sized sand packs have higher porosity and higher permeability, both of which are needed to improve hydrocarbon recovery. Other materials such as engineered proppants, ceramic proppants, or resin coated proppants can be used as substrates as well.

Additionally or alternatively, the substrates described in U.S. Pat. No. 8,661,729 can be used. U.S. Pat. No. 8,661,729 is incorporated herein by reference in its entirety.

All of these particulate materials, as well as any other particulate material which is used as a proppant in the future, can be used as the proppant particle substrate in making the inventive self-suspending proppants.

### Hydrogel Coating

In order to make the inventive proppant self-suspending, the above proppant particle substrate is provided with a coating of a hydrogel-forming polymer in powder form. For this purpose, any polymer material which is capable of taking up (i.e., forming a gel from) 10 to 1000 times its weight in water or more can be used. Hydrogel-forming polymers which are capable of taking up at least 30 times, at least 40 times, at least 50 times, at least 100 times, at least 300 times, at least 500 times, at least 800 times, at least 900 times, or at least 1000 times their weight in water are particularly interesting.

Examples of polymers which are suitable for this purpose include polyacrylamide, hydrolyzed polyacrylamide, copolymers of acrylamide with ethylenically unsaturated ionic co-monomers, copolymers of acrylamide and acrylic acid salts, poly(acrylic acid) or salts thereof, cellulose and its derivatives such as carboxymethyl cellulose, hydroxyethyl cellulose and hydroxypropyl cellulose, starch and its derivatives, guar gum, carboxymethyl guar, carboxymethyl hydroxypropyl guar gum, hydrophobically associating swellable emulsion polymers, etc. Other hydrogel-forming polymers exhibiting similar swelling properties can also be used.

Polyacrylamides, both anionic and cationic, including copolymers of acrylamide with various anionic and cationic comonomers such as acrylic acid and acrylic acid salts of alkaline and alkaline earth metals, can be used. In addition, polymers of acrylamide derivatives such as 2-acrylamido-2-methylpropane sulfonic acid (AMPS) can also be used as can copolymers of such acrylamide derivates with a wide variety of different co-monomers including acrylamide, acrylic acid and acrylic acid salts of alkaline and alkaline earth metals. Poly(acrylamide-co-sodium acrylate), i.e., a copolymer of acrylamide and sodium acrylate, as well as starch and its derivatives, are especially interesting, because of its ability to absorb large amounts of water and to expand to many times its original size.

The average particle size of the hydrogel-forming polymer powder, when dry, should be less than that of the proppant particle substrate. More commonly, the average particle size of the hydrogel-forming polymer powder, when dry, will be ≤50%, ≤25%, ≤10%, ≤7.5%, ≤5%, ≤2.5%, ≤50%, or even ≤1%, of that of the proppant particle substrate. Average particles sizes on the order of 12-140 mesh, 20-100 mesh, 30-100 mesh, and 50-75 mesh are contemplated.

The amount of powdered hydrogel-forming polymer (on a dry solids basis) which is applied to the proppant particle substrate will generally be between about 0.1-20 wt. %, based on the weight of the proppant particle substrate. More commonly, the amount of hydrogel-forming polymer which is applied will generally be between about 0.1-10 wt. % or even 0.5-5 wt. %, based on the weight of the proppant particle substrate. Within these broad ranges, polymer loadings of <5 wt. %, ≤4 wt. %, ≤3 wt. %, ≤2 wt. %, and even ≤1.5 wt. %, are interesting.

Additionally or alternatively, the hydrogel-forming polymers described in U.S. Pat. No. 8,661,729 can be used. U.S. Pat. No. 8,661,729 is incorporated herein by reference in its entirety.

### Binder

In order to cause the hydrogel-forming polymer powder to bond to the proppant particle substrate, the proppant particle substrate is coated with a suitable binder. While this binder can be applied to the proppant particle substrate at the same time as the hydrogel-forming polymer powder, it will normally be applied before this polymer is applied.

Any adhesive capable of bonding the hydrogel-forming polymer powder to the proppant particle substrate can be used as the binder in this invention. Normally, these materials will exhibit significant tack and will be composed, partially or wholly, of one or more naturally-occurring or synthetic tackifiers.

Examples of materials which can be used for this purpose include unreactive waxes such as paraffin wax, reactive waxes such as ethylene bis stearamide, poly(ethylene-co-acrylic acid), poly(ethylene-co-vinyl acetate) or any wax that contains functional groups that are reactive with isocyanates, glues, polyvinyl acetate, low density polyethylenes (LDP, LLDP), gelatin, lignicite, EVA (ethylene vinyl acetate such as Elevate from Westlake and Elvax from DuPont), EMA (ethylene methacrylate such as Elvaloy from DuPont or Optema from ExxonMobil Chemicals), maleic anhydride grafted polyethylenes and polypropylenes (e.g., Fusabond from DuPont), carbohydrate based binders such as starch and its derivatives, hydrogenated starch hydrolysates, various other polysaccharides such as sucrose, for example, common sugar alcohols such as sorbitol, mannitol, maltitol, erythritol, xylitol, and several other tackifiers.

The amount of binder used in particular embodiments of this invention should be enough to bind the desired amount of hydrogel-forming polymer powder to the proppant particle substrate but not so much that the hydrogel-forming polymer powder agglomerates to itself. Generally speaking, this means that the amount of binder can be as little as about 0.1 wt. % and as much as about 3 wt. %, based on the weight of the proppant particle substrate, depending on the particular substrate and binder being used. Binder loadings on the order of 0.15 to 1.0 wt. % or even 0.2 to 0.5 wt. % are more common.

Additionally or alternatively, the binders described in U.S. Pat. No. 8,661,729 can be used. U.S. Pat. No. 8,661,729 is incorporated herein by reference in its entirety.

### Crosslinked Shell

In accordance with this invention, it has been found that important properties of self-suspending proppants of the type described above including both storage stability and durability can be significantly improved by over-coating the proppant with a crosslinking agent capable of reacting with the hydrogel-forming polymer.

Although not wishing to be bound to any theory, it is believed that these properties are improved because the crosslinking agent reacts with the hydrogel-forming polymer from which each powder particle is made, at least at the outer surfaces of these powder particles, to form a unitary, coherent, pervious, protective shell which surrounds the coating layer collectively formed by these discrete polymer powder particles in the aggregate. This pervious, protective shell can be viewed as acting like a net or a mesh in the sense that, when the inventive proppant is wet (i.e., when it is exposed to its aqueous fracturing fluid), this net is open enough to allow rapid and essentially complete hydration of its hydrogel-forming polymer powder particle coating. In addition, it allows these polymer powder particles to swell substantially. As a result, the inventive proppant is still self-suspending in the sense that enough swelling of the outer coating of this proppant occurs to substantially increase its buoyancy in its fracturing fluid while enhancing its shear stability.

In addition to this effect, however, the net or a mesh formed by the crosslinked protective shell of this invention is also strong enough to act as a cage, helping to hold the individual water-expanded polymer powder particles in place on their proppant particle substrate. This prevents these water-expanded polymer particles from being dislodged from this substrate prematurely, i.e., before it reaches its ultimate use location, the result of which is that the durability of the inventive proppant is increased significantly.

On the other hand, when the inventive proppant is dry, this net prevents any significant swelling and hence softening of the surfaces of the hydrogel-forming polymer particles in response to atmospheric moisture. As a result, the inventive proppant particles are prevented from getting too sticky and hence clumping or caking together when dry, even if they are exposed to high humidity conditions in summertime over extended periods of time such as during storage, shipment and the like.

Any chemical which will cause crosslinking of the hydrogel-forming polymer from which the inventive proppants are made can be used as the crosslinking agent in this invention. Examples of ionic crosslinking agents that can be used for this purpose include low molecular weight (e.g., 500,000 to 1,000,000 Daltons) cationic polymers such as polydiallyldimethylammonium chloride (poly-(DADMAC)), linear polyethylenimine (LPEI), branched polyethylenimine (BPEI), chitosan, epichlorohydrin/dimethylamine polymer, ethylene dichloride dimethylamine polymer, and cationic polyacrylamide. Such cationic crosslinking agents are especially useful in connection with crosslinking hydrogel-forming polymers of an anionic nature such as anionic polyacrylamides.

Examples of covalent crosslinking agents that can be used for the purposes of this invention include organic compounds contain or generate at least two of the following functional groups: epoxide, anhydride, aldehyde, isocyanate, carbodiamide, vinyl, or allyl groups. Particular examples of these covalent crosslinkers include: PEG diglycidyl ether, epichlorohydrin, maleic anhydride, formaldehyde, glyoxal, glutaraldehyde, toluene diisocyanate, methylene diphenyl diisocyanate, 1-ethyl-3-(3-dimethylaminopropyl) carbodiamide, methylene bis acrylamide, and the like.

Especially interesting are the diisocyanates such as toluene-diisocyanate, naphthalenediisocyanate, xylene-diisocyanate, tetramethylene diisocyanate, hexamethylene diisocyanate, trimethylene diisocyanate, trimethyl hexamethylene diisocyanate, cyclohexyl-1,2-diisocyanate, cyclohexylene-1,4-diisocyanate, and diphenylmethanediisocyanates such as 2,4′-diphenylmethanediisocyanate, 4,4′-diphenylmethanediisocyanate and mixtures thereof.

In addition to these diisocyanates, analogous polyisocyanates having three or more pendant isocyantes can also be used. In this regard, it is well understood in the art that the above and similar diisocyanates are commercially available both in monomeric form as well as in what is referred to in industry as “polymeric” form in which each diisocyanate molecule is actually made up from approximately 2-10 repeating isocyanate monomer units.

For example, MDI is the standard abbreviation for the particular organic chemical identified as diphenylmethane diisocyanate, methylene bisphenyl isocyanate, methylene diphenyl diisocyanate, methylene bis (p-phenyl isocyanate), isocyanic acid: p,p′-methylene diphenyl diester; isocyanic acid: methylene dip-phenylene ester; and 1,1′-methylene bis (isocyanato benzene), all of which refer to the same compound. MDI is available in monomeric form (“MMDI”) as well as “polymeric” form (“p-MDI” or “PMDI”), which typically contains about 30-70% MMDI with the balance being higher-molecular-weight oligomers and isomers typically containing 2-5 methylphenylisocyanate moieties.

For the purposes of this disclosure, it will be understood that we use “diisocyanate” in the same way as in industry to refer to both monomeric diisocyanates and polymeric isocyanates, even though these polymeric isocyanates necessarily contain more than two pendant isocyanate groups. Correspondingly, where we intend to refer to a simple monomeric diisocyanate, “monomeric” or “M” will be used such as in the designations “MMDI” and “monomeric MDI.” In any event, it will be understood that for the purposes of this invention, all such diisocyanates can be used as the covalent crosslinking agent, whether in monomeric form or polymeric form.

In addition to these diisocyanates, additional polyisocyanate-functional compounds that can be used as the covalent crosslinking agents of this invention are the isocyanate-terminated polyurethane prepolymers, such as the prepolymers obtained by reacting toluene diisocyanate with polytetramethylene glycols. Isocyanate terminated hydrophilic polyurethane prepolymers such as those derived from polyether polyurethanes, polyester polyurethanes as well as polycarbonate polyurethanes, can also be used.

In this regard, it is desirable when making the inventive humidity-resistant self-suspending proppant that the covalent crosslinking agents be in liquid form when combined with the other ingredients of the coating compositions. This is because this approach enhances the uniformity with which this crosslinking agent is distributed in the coating composition and hence the uniformity of the crosslinked layer or shell that is ultimately produced.

For this purpose, particular crosslinking agents can be selected which are already liquid in form. For example, pMDI and other analogous diisocyanates can be used as is, as they are liquid in form as received from the manufacturer. Additionally or alternatively, the crosslinking agent can be dissolved in a suitable organic solvent. For example, many aliphatic diisocyanates and polyisocyanates are soluble in toluene, acetone and methyl ethyl ketone, while many aromatic diisocyanates and polyisocyanates are soluble in toluene, benzene, xylene, low molecular weight hydrocarbons, etc. Dissolving the isocyanate in an organic solvent may be very helpful, for example, when polymeric and other higher molecular weight diisocyanates are used.

In particular embodiments of this invention, (1) the hydrogel-forming polymer used to make the inventive self-suspending proppants will be formed from an acrylamide polymer or copolymer and in particular an anionic polyacrylamide, i.e., a copolymer of acrylamide and at least one other anionic monomer such as acrylic acid, sodium acrylate, ammonium acrylate, acrylamidomethylpropane sulfonic acid (AMPS), the sodium salt of AMPS (NaAMPS), etc.

The amount of crosslinking agent that should be used in particular embodiments of this invention should be enough to form a crosslinked shell on the entire surface of the hydrogel-forming polymer coating on each proppant particle but not so much as to cause these proppant particles to undergo premature consolidation, i.e., formation of proppant agglomerates before the individual proppant particles reach their ultimate use location downhole.

The amount of crosslinking agent that should be used in particular embodiments of this invention can be as small as about 0.1 wt. % and as much as about 3 wt. %, based on the weight of the proppant particle substrate, depending on the particular substrate and binder being used. Amounts of crosslinking agents on the order of 0.15 to 1.0 wt. % or even 0.2 to 0.5 wt. %, on the same basis, are more common.

### Catalyst for Cross-Linking Agent

In accordance with another feature of this invention, at least when covalent crosslinking agents are used, a catalyst (also referred to as an “accelerator”) can be included in the coating composition to facilitate the reaction of the covalent crosslinking agent with the hydrogel-forming polymer, as well as any other reactive chemical specie that may also be included in the composition.

Common types of catalysts or accelerators for many crosslinking agents include acids such as different sulfonic acids and acid phosphates, tertiary amines such as triethylenediamine (also known as 1,4-diazabicyclo[2.2.2]octane (Dabco from Air Products, Inc.) or diaminopropyl-dimethyl propanediamines offered by Air Products under the trade names Polycat 9, 34, 41, etc., or DiazoBicycloUndecene offered under the tradename Polycat DBU and metal compounds such as lithium aluminum hydride and organotin, organozirconate and organotitanate compounds. Examples of commercially available catalysts include Tyzor product line (Dorf Ketal); NACURE, K-KURE and K-KAT product lines (King Industries); JEFFCAT product line (Huntsman Corporation) etc. Any and all of these catalysts can be used to accelerate the crosslinking reaction occurring in the inventive technology.

The amount of catalyst for the crosslinking agent that should be used in particular embodiments of this invention should at least be enough to catalyze a substantial amount of the covalent crosslinking being used. If desired, however, more catalyst can be used. Catalyst concentrations on the order of at least 50%, at least 75%, at least 100%, at least 125%, at least 150%, at least 175% and at least 200% of the amount of crosslinking agent used, on a molar basis, are contemplated.

### Method of Manufacture

The preliminary product comprising the proppant particle substrate, an intermediate binder layer and a coating layer of a hydrogel-forming polymer in powder form can be made in a conventional manner such as described in the above-noted U.S. Pat. No. 8,661,729, the disclosure of which is incorporated herein by reference. Specifically, it is envisioned that the substrate will be coated with the binder, for example, by a blender or rotary mixer. The substrate can be added to the mixer, binder added in an amount sufficient to provide an even coating over the particle substrate. Hydrogel-forming polymer powder can then be added to the mixer while mixing.

The crosslinked shell of this invention can be formed during manufacture of this preliminary product by adding the ingredients forming this crosslinked shell, preferably in liquid form, after the powdered hydrogel-forming polymer is added to the other ingredients forming this preliminary product. Normally, this will be done under conditions which will enable these ingredients to react with and crosslink the hydrogel-forming polymer found at the exposed surfaces these polymer particles, i.e., the surfaces of these hydrogel-forming polymer powder particles which are not covered or otherwise blocked with binder. Most conveniently, this can be done as a separate, subsequent step in the manufacture of this preliminary product such as simply by adding these ingredients to this preliminary product after it has substantially formed in the same mixing equipment in which this preliminary product is made and without removing this preliminary product from this equipment.

Most commonly, this will be done by adding these ingredients shortly after the hydrogel-forming polymer powder is added. Delay times between the end of the polymer powder addition and the start of the crosslinking agent addition can be as short as 0.1 second and as long as days or even longer. Delay times on the order of 1 second to 24 hours, 30 seconds to 1 hour, or even 2 to 10 minutes are more common. Thereafter, the reaction mixture composed of all these ingredients will continue to be mixed until the crosslinking reaction has been completed. While this continued mixing can be carried out at room temperature, normally it will be carried out at an elevated temperature which is sufficient to activate the crosslinking catalyst, thereby speeding the reaction.

In this regard, in many instances, the preliminary product comprising the proppant particle substrate carrying a coating of a hydrogel-forming polymer in powder form will already be at an elevated temperature, since it may be desirable to heat the binder to speed and/or otherwise facilitate its ability to bind the subsequently applied hydrogel-forming polymer powder particles. If so, this preliminary product may already be at an appropriate elevated temperature, in which case no additional heating may be required.

In other instances, the binder may not be heated during manufacture of the preliminary product, or the amount of heating done during preliminary manufacture may be insufficient for activating the subsequently applied crosslinking agent and/or catalyst. If so, additional heating may be necessary or desirable to speed the crosslinking reaction along.

In any event, in those instances in which additional heat is supplied to the reaction system for causing and/or accelerating the crosslinking reaction, care should be taken to avoid heating the reaction system above the melting and/or decomposition temperature of the particular binder employed so as to avoid destroying and/or deactivating the preliminary product before the crosslinked shell can form.

### Properties

As indicated above, in order to be commercially viable, a self-suspending proppant desirably should exhibit at least three different but related properties. First, it should be self-suspending in the sense that its buoyancy substantially increases shortly after it is added to its aqueous fracturing fluid. Second, it should be storage stable in the sense that it resists caking and agglomeration when stored in bulk under hot and humid conditions in summertime. Third, it should be durable in the sense that its hydrogel coating, which is responsible for its self-suspending nature, remains largely intact until it reaches its ultimate use location downhole.

With respect to the first of these properties, the ability of a proppant to be self-suspending, this property can be determined by a Settled Bed Height Analytical Test in which 1 g of the dry modified proppant to be tested is added to 10 g of water (e.g., tap water) at approximately 20° C. in a 20 mL glass vial. The vial is then agitated for about 1 minute (e.g., by inverting the vial repeatedly) to wet the modified proppant coating. The vial is then allowed to sit, undisturbed, for 10 minutes. The height of the bed formed by the hydrated modified proppant can be measured using a digital caliper. This bed height is then divided by the height of the bed formed by the dry proppant. The number obtained indicates the factor (multiple) of the volumetric expansion. Also, for convenience, the height of the bed formed by the hydrated modified proppant can be compared with the height of a bed formed by uncoated proppant, as the volume of uncoated proppant is virtually the same as the volume of a modified proppant carrying a hydrogel coating, when dry.

In accordance with this invention, the type and amount of hydrogel forming polymer powder which is applied, as well as the type and amount of hydrogel polymer crosslinking agent which is applied, are selected so that the inventive self-suspending proppants preferably exhibit a volumetric expansion, as determined by this Settled Bed Height Analytical test, of ≥1.5. More desirably, these proppants will exhibit a volumetric expansion of ≥˜3, ≥˜4, ≥˜5, ≥˜7, ≥˜8, ≥˜10, ≥˜11, ≥˜15, ≥˜17, or even ≥˜28, when measured by this test. Of course, there is a practical maximum to the volumetric expansion the inventive proppants can achieve, which will be determined by the particular type and amount of hydrogel-forming polymer used in each application.

With respect to the second of these properties, storage stability, this property can be determined by a Humidity Resistance Test in which the proppant to be tested is subjected to a relative humidity of about 80%-90% for one hour at 25-35° C. If the proppant remains free-flowing after this test, it will be considered storage stable. In this context, a proppant will be considered “free-flowing” if any clumping or agglomeration it may experience can be broken up by gentle agitation.

The third property a self-suspending proppant should have for commercial viability is durability. In other words, the hydrogel coating of the proppant should remain largely intact and not be substantially dislodged prior to the proppant reaching its ultimate use locations downhole.

In this regard, it will be appreciated that proppants inherently experience significant mechanical stress when they are used, not only from pumps which charge the fracturing liquids in which they are contained downhole but also from overcoming the inherent resistance to flow encountered downhole due to friction, mechanical obstructions, sudden changes in direction, etc. Hydrogel coatings, by their very nature, are inherently fragile. However, in accordance with this invention, these hydrogel coatings are rendered more durable by forming a crosslinked shell on their outer surfaces.

For the purposes of this invention, the durability of a self-suspending proppant can be determined by a Shear Analytical Test in which a batch of the proppant is sheared at about 550 s⁻¹ for 5, 10, 20 or more minutes. A self-suspending proppant is considered durable if the volumetric expansion it exhibits after this Shear Analytical Test, as determined by the above Settled Bed Height Analytical test, is ≥1.5. More desirably, these proppants will exhibit a volumetric expansion of ≥˜2, ≥˜3, ≥˜4, ≥˜5, ≥˜8, ≥ or even ˜10, when measured by this test.

In addition to shearing ratio, another means for determining durability is to measure the viscosity of the supernatant liquid that is produced by the above Shear Analytical Test after the proppant has had a chance to settle. If the durability of a particular proppant is insufficient, an excessive amount of its hydrogel polymer coating will become dislodged and remain in the supernatant liquid. The extent to which the viscosity of this liquid increases is a measure of the durability of the hydrogel coating. A viscosity of about 20 cps or more when a 100 g sample of modified proppant is mixed with 1 L of water in the above Shear Analytical test indicates a low coating durability. Desirably, the viscosity of the supernatant liquid will be about 10 cps or less, more desirably about 5 cps or less.

In accordance with this invention, a self-suspending proppant which is made from a hydrogel-forming polymer in powder form can be made so that it passes all three of the above analytical tests by adopting the technology of this invention. Thus, this invention provides a self-suspending proppant which, not only is made self-suspending by means of a coating of a hydrogel-forming polymer in powder form, but in addition also exhibits (a) a volumetric expansion as determined by the above Settled Bed Height Analytical test of ≥1.5, (b) storage stability as determined by the above Humidity Resistance Test, and (c) a durability of ≥1.5 as determined by the above Shear Analytical Test.

### EXAMPLES

In order to more thoroughly describe this invention, the following working examples are provided.

In these examples, 1 kg of washed 20/40 sand, which had been heated to above 160° F., was added to the mixing bowl of a KitchenAid mixer. 2.5 g of the particular binder used, as noted in Table 1 below, was then added with continuous mixing. Those binders which are solid at room temperature were granulated in form. Approximately 90 seconds after the binder was added, 30 g of powdered poly(acrylamide-co-sodium acrylate) was then added. Mixing continued until the temperature of the mixture had cooled to less than 100° F., after which 2.5 g of a commercially-available p-MDI (Rubinate 1245 from Huntsman Chemical) was added with continuous mixing followed 2 minutes later with the addition of a 2 g of a commercially-available tertiary amine catalyst for the p-MDI (Polycat 9-10% solution—from Air Products). Mixing was continued for an additional 1.5 minutes, and the mixture allowed to dry at 140° F. for at least 30 additional minutes, thereby producing a free flowing product.

In this procedure, latent heat from the sand melted those binders which were solid in form, allowing the surfaces of the individual sand grains to be evenly coated. As the mixture cooled, the binder solidified, binding the poly(acrylamide-co-sodium acrylate) powder in place. Addition of the p-MDI and tertiary amine catalyst coated the surface of the sand/binder/polymer blend and reacted with itself and with the polymer to form a crosslinked shell, thereby imparting shear stability to the system.

Essentially the same thing occurred in Example 5 in which the binder was supplied in the form of an aqueous emulsion rather than a granulated solid, except that the latent heat of the sand evaporated the aqueous carrier liquid from the emulsion, allowing the polymer binder therein to bind the poly(acrylamide-co-sodium acrylate) powder in place.

Note that, in all of these examples, the drying temperature was high enough to drive the crosslinking reaction to completion but not so high as to melt the binder.

The durability of the self-suspending proppants made in these examples was determined by means of the Shear Analytical Test described above carried out twice, once in which the settled bed height was determined after 5 minutes of shear mixing and a second time in which the settled bed height was determined after 10 minutes of shear mixing. This was accomplished using an ECE CLM4 mixer in the following way:

Two 1 L beakers designed for use with this mixer were filled with 1 L of water each. 100 g of the sample to be tested was poured into the mixing beaker, and mixed at 275 rpm, which corresponds to a shear rate of about 550 s⁻¹. Mixing was continued for either 5 or 10 minutes, after which the mixer was turned off and the sample allowed to settle for 10 minutes. After settling, the bed height was measured.

In addition to determining durability by means of the above Shear Analytical Test, the durability of these proppants was also determined by measuring the viscosity of the supernatant liquids that were produced by this test using a Fann 35 type viscometer with an R1B1 rotor-bob setup.

The results obtained are set forth in the following Table 1:

TABLE 1
Durability of Inventive Proppants

| | | 5 minute | | 10 minute | |
|---|---|---|---|---|---|
| | | mixing | | mixing | |
| | | Bed | | Bed | |
| | | height | Viscosity | height | Viscosity |
| Example | Binder | (mm) | (cP) | (mm) | (cP) |
| 1 | Unreactive Wax | 20-30 | 2 | 15-25 | 4 |
| 2 | Reactive Wax | 20-30 | 2 | 15-25 | 4 |
| 3 | Molasses | 20-30 | 2 | 15-25 | 4 |
| 4 | Polyvinyl acetate | 20-30 | 2 | 15-25 | 4 |
| | powder | | | | |
| 5 | Polyvinyl acetate | | | | |
| | emulsion | 20-30 | 2 | 15-25 | 4 |
| | (Elmer's Glue) | | | | |
| 6 | Starch | 25-35 | 2-3 | 20-30 | |
| 7 | Arrmaz (sugar | | | | |
| | based, 1% soln.) | 11 | 23 | 23 | 30 |
| 8 | Sodium silicate | 11 | 25 | 22 | 29 |
| Bare | | 10 | 1 | 10 | 1 |
| Sand | | | | | |
| 20/40 | | | | | |
| mesh | | | | | |

As can be seen from Table 1, the inventive proppants exhibited a settled bed height which was 2 to 3 times greater than that of bare sand after 5 minutes of mixing at a shear rate of about 550 s⁻¹ and 1.5 to 2 times greater than that of bare sand after 10 minutes of mixing at this shear rate. Since the thickness of the surface crosslinked hydrogel-forming polymer coating of the inventive proppants is essentially negligible, the settled bed height of bare sand is an appropriate control to measure the volumetric expansion of the these coatings.

Similarly, the viscosities of the supernatant liquids obtained from these Shear Analytical Tests were only 2 cP after the 5-minute mixing test and 4 cP after the 10-minute mixing test.

These results demonstrate that the hydrogel coatings of the inventive self-suspending proppants not only undergo substantial swelling when exposed to water but, in addition, are also highly durable.

Although only a few embodiments of this invention have been described above, it should be appreciated that many modifications can be made without departing from the spirit and scope of the invention. All such modifications are intended to be included within the scope of this invention, which is to be limited only by the following claims.

1. A self-suspending proppant comprising a proppant particle substrate, a binder on the surface(s) of the proppant particle substrate, and a layer of a powder of a hydrogel-forming polymer bound to the surface(s) of the proppant particle substrate by the binder, wherein the self-suspending proppant further comprises a crosslinked shell.

2. The self-suspending proppant of claim 1, wherein the hydrogel-forming polymer is an acrylamide polymer.

3. The self-suspending proppant of claim 1, wherein the hydrogel-forming polymer is poly(acrylamide-co-sodium acrylate).

4. The self-suspending proppant of claim 1, wherein the hydrogel-forming polymer has a particle size of 12-140 mesh.

5. The self-suspending proppant of claim 1, wherein the crosslinked shell is produced by adding a covalent crosslinking agent.

6. The self-suspending proppant of claim 5, wherein the crosslinking agent is a diisocyanate.

7. The self-suspending proppant of claim 6, wherein the diisocyanate is p-MDI.

8. The self-suspending proppant of claim 1, wherein the self-suspending proppant exhibits (a) a volumetric expansion as determined by the Settled Bed Height Analytical test described in the specification of ≥1.5, (b) storage stability as reflected by the fact that it remains free flowing after having been subjected to a relative humidity of about 80%-90% for one hour at 25-35° C., and (c) a durability of ≥1.5 as determined by the Shear Analytical Test described in the specification.

9. The self-suspending proppant of claim 8, wherein the hydrogel-forming polymer is an acrylamide polymer and further wherein the crosslinked shell is produced by adding a covalent crosslinking agent.

10. The self-suspending proppant of claim 9, wherein the hydrogel-forming polymer is a copolymer of acrylamide and acrylic acid or an alkali metal acrylic acid salt and further wherein the crosslinking agent is a diisocyanate.

11. A process for improving the durability of a self-suspending proppant comprising a proppant particle substrate, a binder on the surface(s) of the proppant particle substrate, and a layer of a hydrogel-forming polymer in form of powder particles bound to the surface(s) of the proppant particle substrate by the binder, the process comprising applying a crosslinking agent capable of crosslinking the hydrogel-forming polymer to these powder particles after they have been contacted with the binder.

12. The process of claim 11, wherein the hydrogel-forming polymer is an acrylamide polymer.

13. The process of claim 11, wherein the hydrogel-forming polymer is poly(acrylamide-co-sodium acrylate).

14. The process of claim 11, wherein the hydrogel-forming polymer has a particle size of 12-140 mesh.

15. The process of claim 11, wherein the crosslinking agent is covalent.

16. The process of claim 15, wherein the crosslinking agent is a diisocyanate.

17. The process of claim 16, wherein the diisocyanate is p-MIDI.

18. A process for improving the durability of a self-suspending proppant comprising a proppant particle substrate, a binder on the surface(s) of the proppant particle substrate, and a layer of powdered hydrogel-forming polymer on the binder, wherein the powdered hydrogel-forming polymer is contacted with the binder by adding the powdered hydrogel-forming polymer to a mixture of the proppant particle substrate and the binder, the process comprising applying a crosslinking agent capable of crosslinking the hydrogel-forming polymer to the mixture of the proppant particle substrate and the binder after the powdered hydrogel-forming polymer is added to this mixture.

19. The process of claim 18, wherein the hydrogel-forming polymer is an acrylamide polymer.

20. The process of claim 11, wherein the crosslinking agent is covalent.

21. The process of claim 20, wherein the crosslinking agent is a diisocyanate.
